(19) United States
(12) Patent Application Publication
(10) Pub. No.: US 2009/0098259 A1
(43) Pub. Date: Apr. 16, 2009

(54) Sanitizing salad spinner and methods

(76) Inventor: John J. McEllen, Cleveland, OH (US)

Correspondence Address: ROGERS & KILLEEN, 3260 LUVAN BOULEVARD, GEORGETOWN, SC, 29440, US

(21) Appl. No.: 12/287,734

(22) Filed: Oct. 14, 2008

Related U.S. Application Data
(60) Provisional application No. 60/999,230, filed on Oct. 12, 2007.

(51) Int. Cl. A23L 3/28; A23B 7/015; A47J 43/24

(52) U.S. Cl. 426/240; 99/451; 99/511; 426/506

(57) ABSTRACT

Methods and apparatus for the sanitation and surface disinfection of edible produce such as lettuce, spinach and other leafy vegetables and fruits and vegetables such as apples, plums, pears, tomatoes having a protective skin. A centrifuge for receiving washed produce may be selectively spun to remove excess washing fluid, irradiated with UV-C energy and/or exposed to an ozone field while within the centrifuge. Air may be used for evaporative drying of the washed produce.

### PRIORITY CLAIM

Applicant claims the priority of Provisional Application Ser. No. 60/999,230 filed Oct. 12, 2007.

### BACKGROUND OF THE INVENTION

The present invention relates to methods and apparatus for the sanitation and surface disinfection of edible produce such as lettuce, spinach and other leafy vegetables and fruits and vegetables such as apples, plums, pears, tomatoes having a protective skin.

The lettuce, spinach and other leafy vegetables commonly used in salads frequently contain e-coli, salmonella, listeria or other bacteria. Food preparers often rinse/wash the vegetables with water and even detergents in an effort to reduce germs. This thorough washing of the leafy vegetables results in undesirable retention of the washing fluid and devices that spin or press the vegetables to drain the excess washing fluid have been adopted to keep the vegetables from becoming soggy or mushy.

To avoid the necessity for washing vegetables in an attempt to remove dirt, germs and pesticides, many consumers purchase their vegetables in pre-washed “bagged” containers. While convenient, bagged vegetables products require more handling than “whole” products and more surface area is exposed to bacteria downstream in food processing and preparation.

The germ killing nature of ultraviolet “C” radiating lamps (253.7 nm) and ozone (O^{3,3+}) are well known. The anti-oxidant nature of ozone is also well known. UV-C Lamps that simultaneously radiate at 185 nm are known to create ozone, thus providing germ killing and anti-oxidation with a single source. Attempts to market bagged “irradiated” or sterilized vegetables recently have been made but have not been successful because the taste and appearance are affected adversely. In addition, the food may be recontaminated in further processing.

The present invention includes a centrifuge for removing excess water from the vegetables by centrifugal force. The removal of this excess moisture also allows the surface of the vegetables to be penetrated by UV-C energy. Following the drying process, the vegetables are irradiated with UV-C energy within the centrifuge for a period of time sufficient to reduce the concentration of common bacteria, e.g., e-coli, by up to 99% on lettuce, spinach and other leafy vegetables. The spinning continues for a period of time sufficient for the ozone generated by the radiation at 185 nm to detoxify the produce and then to dissipate or to attach harmlessly to the produce, after which the produce may be removed from the centrifuge.

Many other objects and advantages will be apparent from the following detailed description of preferred embodiments when read in conjunction with the appended drawings.

### THE DRAWINGS

FIG. 1 is a pictorial representation of one embodiment of the spinner of the present invention.

FIG. 2 is a pictorial representation of the wire basket inserted into the spinner of FIG. 1.

FIG. 3 is a pictorial representation of the drip pan inserted into the spinner of FIG. 1.

FIG. 4 is a schematic representation in elevation showing the insertion of the basket and drip pan into the housing of the embodiment of FIG. 1.

### THE DETAILED DESCRIPTION

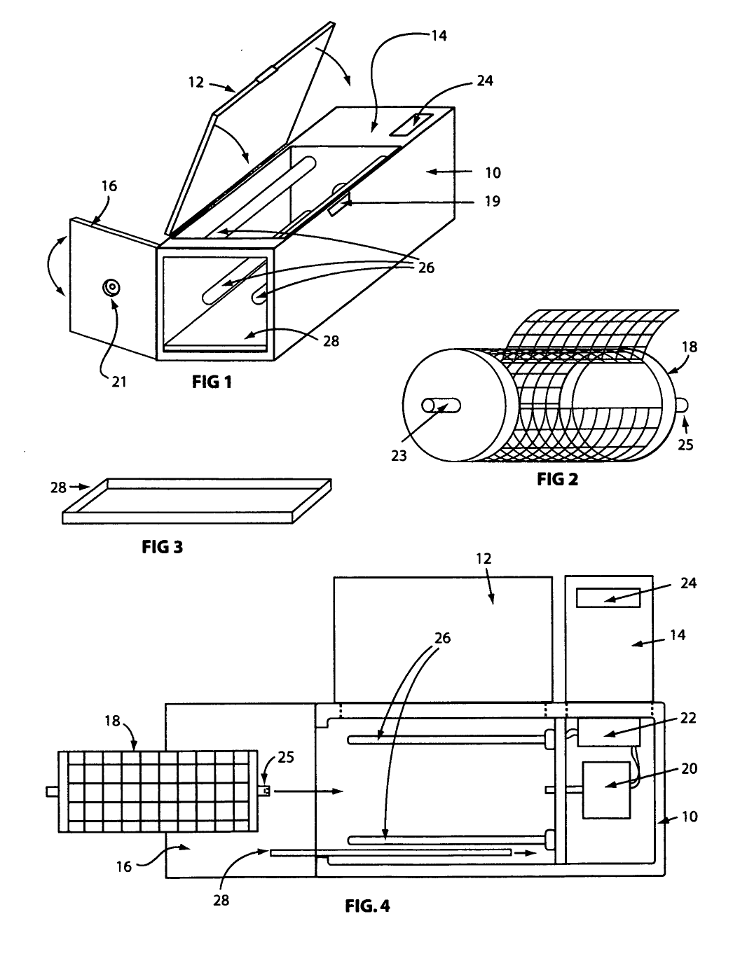

Referring now to the drawings wherein like numbers have been used for like elements, FIG. 1 shows a preferred embodiment of the appliance of the present invention. As illustrated in FIG. 1, there is a two compartment housing 10 that includes a top door 12, 14 for each compartment and an end door 16. The larger compartment houses the centrifuge wire-mesh basket 18 (shown in FIG. 2) which is conventionally driven by an electric motor 20 housed in the smaller compartment. The inside surface of the end door 16 desirably contains a receptacle 21 for rotatably supporting one axle 23 of the basket 18, the other axle 25 of the basket 18 being removably connected to the shaft of the motor 20. The controls 22 for the appliance are accessible from the top of the housing 10 through an opening 24 in the top door 14 and may be mounted in the compartment or attached to the underside of the top door 14.

A plurality of single-ended lamps 26, desirably four, are mounted on the wall between the two compartments and extend horizontally adjacent the corners of the centrifuge compartment. These lamps are UV-C generating sources for generating radiation in the UV-C and ozone causing frequency bands, e.g. 253.7 nm and 185 nm. These lamps are fluorescent in the preferred embodiment but other conventional sources may be employed, e.g., light emitting diodes (“LED's”). Fluorescent or LED sources that are opaque to the transmission of ozone in that they emit energy at 253.7 nm but not 185 nm may also be used. The operation of the sources 26 is controlled by the controls 24 in the smaller compartment.

The larger and centrifuge containing portion of the housing 10, including the doors, is opaque to UV-C energy so that the UV-C energy is contained within the housing. All doors are provided with suitable seals to contain the ozone within the housing.

As shown in FIG. 2, the basket 18 is desirably a wire mesh screen with solid ends and outwardly protruding axles 23, 25. The interior of the basket is desirably formed with “shelves” to tumble the leafy vegetables and to thus expose the entire surface thereof to UV-C radiation and facilitating oxidation from the ozone during operation of the appliance.

A drip pan 28 (shown in FIG. 3) is removably inserted into the centrifuge portion of the housing 10 through the open end door 16 and may rest on the floor of the centrifuge compartment.

In operation, the basket may be removed from the housing. The vegetables may be washed with water or other suitable washing fluid and placed in the basket 18, and the basket 18 then placed within the centrifuge. Alternatively, produce such as leafy vegetables may be dropped through the open top door 12 of the housing 10 into the wire basket 18 with the end door 16 closed and latched by clasp 19.

A removable drip pan 2 is provided beneath the basket 16 in the centrifuge housing to accumulate washing fluid removed from the produce.

The centrifuge may then be operated to rotate the basket 18 to remove excess washing fluid. The radiation sources 26 can be energized simultaneously with or following a predetermined period of rotation for washing fluid removal. A small fan (not shown) may be added to circulate air through the centrifuge to aid in the drying of the produce. The fan may be mounted in any of the centrifuge housing walls to draw air into the centrifuge, and an exhaust opening is desirably provided in the centrifuge wall facing the fan. Suitable conventional interlocks may be provided to insure that the fan will operate and the exhaust opening opened when the centrifuge is in use but not when the UV-C and/or ozone generating source is enabled.

The rotation of the basket in the irradiation/oxidation field desirably continues for a period of time after which the sources 26 are extinguished. The basket 18 desirably continues to rotate for a sufficient time to allow the ozone generated to adhere harmlessly to the surface of the produce. After this period, an indicator light and/or sonic indicator on the control panel 22 may indicate that the end door 16 of the housing may be safely opened and the produce removed from the centrifuge basket 18.

Any suitable conventional control circuit, desirably programmable, may be used to vary the duration and cycle of the appliance.

Once the centrifuge basket 16 is removed, the drip pan 28 may be removed to empty the washing fluid and for cleaning.

The present invention may also be used in a static or non-rotating mode for foods such as apples, pears, plums tomatoes, etc. which are protected from internal contamination by a skin and where it is desirable to destroy the germs on the skin without bruising the fruit or vegetables.

While the foregoing is a description of preferred embodiments, many variations and modifications will naturally occur to those of skill in this art from a perusal hereof. The invention is therefore not to be limited to the embodiments disclosed, but defined only by the claims when accorded a full range of equivalents.

I claim:

1. A food preparation appliance including a housing having a centrifuge for (a) spin drying produce washed in a washing fluid to remove excess washing fluid therefrom and (b) for reducing germs on the produce within the centrifuge by exposure to at least one of (a) UV-C radiation and (b) an oxidizing field while the produce is contained within the centrifuge.

2. The appliance of claim 1 wherein said housing is opaque to UV-C radiation.

3. The appliance of claim 1 wherein said housing is sealed to contain ozone within the centrifuge.

4. The appliance of claim 1 including a plurality of UV-C radiation sources within said centrifuge.

5. The appliance of claim 1 wherein said centrifuge includes a removable produce basket.

6. The appliance of claim 1 wherein said centrifuge contains a removable drip pan.

7. The appliance of claim 1 including means for selectively programming the sequence and duration of drying and germ reducing cycles.

8. The appliance of claim 1 including a fan for passing air through the centrifuge to provide evaporative drying.

9. The appliance of claim 8 including means for preventing the operation of said fan when an oxidizing field is present in the centrifuge.

10. A food preparation appliance including a housing having an ozone confining housing into which produce may be removably received and a source of ozone producing radiation within said housing for reducing germs on the produce.

11. The appliance of claim 10 wherein said housing is static.

12. A method of preparing produce washed in a washing fluid including the steps of:
(a) spinning the produce within a centrifuge to remove excess washing fluid; and
(b) irradiating the produce within the centrifuge with UV-C energy to reduce germs.

13. The method of claim 12 wherein the irradiation of the produce takes place at least in part during the spinning of the produce.

14. The method of claim 12 wherein the irradiation of the produce takes place following the spinning of the produce.

15. The method of claim 12 including means for selectively passing air through the centrifuge when an oxidizing field is not present within the centrifuge.

16. A method of reducing the germs on produce comprising the steps of:
(a) introducing produce into an ozone confining housing having an internal sources of ozone causing radiation; and
(b) energizing the source for a time sufficient to reduce the germs on the produce.

17. The method of claim 16 including means for selectively passing air through the housing in the absence of an oxidizing field within the housing.
